(19) United States
(12) Patent Application Publication
(10) Pub. No.: US 2015/0138020 A1
(43) Pub. Date: May 21, 2015

(54) INTRINSICALLY SAFE HOUSING AND ANTENNA DESIGN FOR A RADIO DEVICE AND METHOD OF FORMING SAME

(71) Applicant: MOTOROLA SOLUTIONS, INC, SCHAUMBURG, IL (US)

(72) Inventors: ROSHAN BAPURAO KHOBRAGADE, PULAU PENANG (MY); SOLOMON ARULANANDAM LORTHU, GEORGE TOWN (MY); CHEAH HENG TAN, BAYAN LEPAS (MY); WOOI PING TEOH, GEORGETOWN (MY)

(73) Assignee: MOTOROLA SOLUTIONS, INC, SCHAUMBURG, IL (US)

(21) Appl. No.: 14/081,681

(22) Filed: Nov. 15, 2013

(51) Int. Cl. H01Q 1/24

(52) U.S. Cl. CPC H01Q 1/243
USPC 343/702; 29/600

(57) ABSTRACT

A radio device housing uses an exterior layer or surface made of an electrically conductive anti-static material that is formed over an interior or inner layer that is made of a non-conductive material. The anti-static material prevents the accumulation of static charge on the device housing in accordance with intrinsically safe design standards. An antenna portion is formed on a section of the non-conductive material that is not covered by the conductive material. An antenna element is disposed on the antenna portion and coupled to a radio circuit inside the device.

### FIELD OF THE DISCLOSURE

The present disclosure relates generally to radio devices, and in particular to housings for portable two-way radio devices having local and/or short range radio transceivers in addition to the main two-way transceiver, and which are designed to be intrinsically safe for use in the presence of combustible air-dispersed substances.

### BACKGROUND

The portable two-way radio device has been a very useful communication tool for several decades, and despite the development other types of communication devices such as cellular phones, portable two-way radio devices are still the primary communication tool in a wide variety of applications. The persistent popularity of these devices is due to their ability to allow a user to communicate almost instantly with a large number of others in an organization. A portable two-way radio device, and two-way radio devices in general, use a “push to talk” (PTT) operation where a user presses or “keys” a PTT button, and the device, in response, begins transmitting audio signals received at a microphone of the device. In more sophisticated systems, the device can first check a radio channel and give the user an indication that transmission has begun when the channel is clear. In addition, when audio signals are transmitted on a channel monitored by the two-way radio device, it will commence playing the audio as it is being received. Thus, the user does not have to take any action or operate the device in any way in order to hear the received audio signals.

Given the advantages of portable two-way radio devices, they are used in many situations by various organizations, including public safety, rescue, security, and industrial applications. In some situations, a person using a portable two-way radio device can be located in an area where there are volatile gasses, mists, vapors, or dust present. An electronic device that is battery powered, such as a portable two-way radio device, can be a source of ignition of such materials if the device is faulty, used improperly, or if it produces a static discharge sufficient to ignite volatile air-dispersed materials. In order to avoid a potential ignition of such air-dispersed material, manufacturers and agencies have developed design standards for product design in order to produce intrinsically safe devices, meaning that a product or device complying with those standards are designed to avoid ignition events even if the device experiences a fault condition, malfunctions, or is used improperly. An example of one such agency is the European Commission's standard for Equipment and Protective Systems for Potentially Explosive Atmosphere, known commonly by the acronym ATEX.

One aspect of device design under such safety standards is the prevention of static electric charge on the housing of a device. Given that polymeric materials is often used to form housing components, the housing can be a source of static charge. One method for avoiding static charge from accumulating on a device housing is to design the housing of the device to have an outer surface that is electrically conductive, or at least electrically conductive enough to prevent an unsafe level of static charge accumulation. However, covering the exterior of a device with electrically conductive material presents some problems. In particular, it is now common in portable two-way radio devices to include short range, high frequency transceivers, in addition to the main two-way communication transceiver. Examples of short range communications include wireless local area network (WLAN) transceivers that operate under the Institute of Electrical and Electronic Engineers (IEEE) standard 802.11, and personal area network (PAN) transceivers operating under IEEE standard 802.15 (including the commercially known BlueTooth standard), among others. While the two-way communication transceiver will typically use an external whip antenna, these local and short range transceivers, because of their high frequency, more typically use internal antennas for efficiency and device aesthetics. Covering a device with an electrically conductive material, however, would greatly reduce the efficacy of such internal antennas.

Accordingly, there is a need for an apparatus and housing that prevents static charge accumulation on the surface of the device and which allows antennas for local and short range transceivers to operate effectively alongside two-way transceiver in portable two-way radio devices.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a top cutaway view of a device housing, in accordance with some embodiments;

FIG. 2 is a front view of an antenna portion and antenna for a device, formed on the housing of the device, in accordance with some embodiments;

FIG. 3 is a plurality of nested antenna elements on an antenna portion of a device housing, in accordance with some embodiments;

FIG. 4 is a top cutaway view of a device assembly, in accordance with some embodiments;

FIG. 5 is an isometric view of a portable two-way radio device having an electrically conductive outer layer and an antenna portion formed on an exposed region of an non-conductive interior layer of a housing, in accordance with some embodiments;

FIG. 6 is a flow chart diagram of a method for forming a device housing having a conductive exterior layer for a portable device, in accordance with some embodiments; and

FIG. 7 is a block diagram of a portable two-way radio device 700 in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Embodiments include a portable two-way radio device that has a housing having an outer surface that is covered with an anti-static material. The anti-static material is excluded from an antenna portion of the outer surface of the housing, exposing an area of a non-conductive interior layer of the housing. The portable two-way radio device further includes at least one antenna element formed on the antenna portion. The antenna element (or elements) has a feed point that is connected to an interior space of the portable two-way radio device through the housing. The antenna element is a planar element disposed on the surface of the antenna portion. A radio circuit is disposed in the interior space of the portable two-way radio device and is coupled to the antenna element. This allows for a concealable antenna element on a surface of the portable two-way radio device where the portable two-way radio device is substantially covered in an electrically conductive anti-static material to prevent the accumulation of static charge.

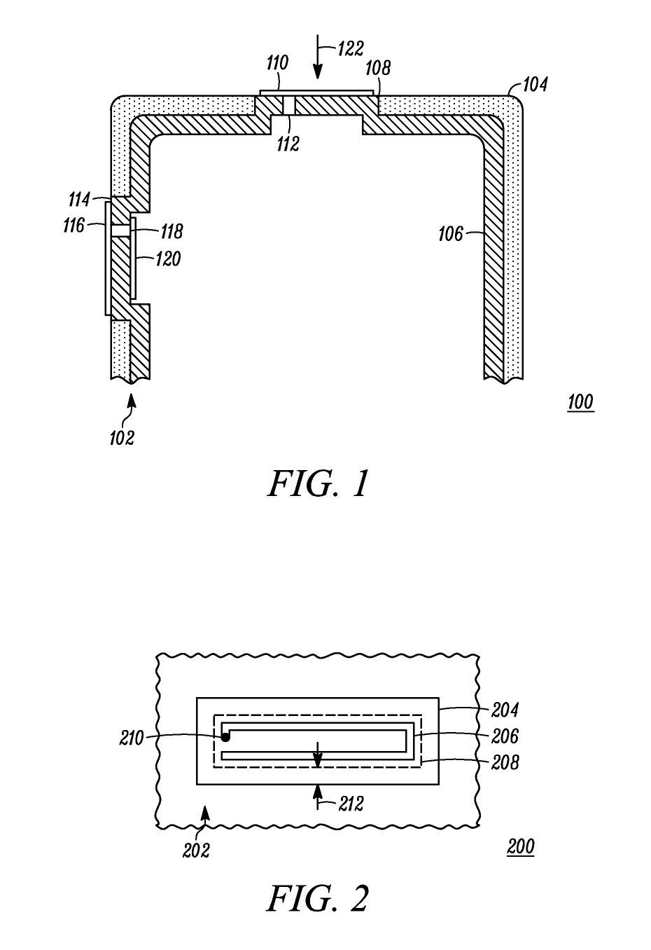

FIG. 1 is a top cutaway view 100 of a device housing 102, in accordance with some embodiments. The portion of the housing 102 shown here can be the front and sides of a device such as a portable two-way radio device. The housing is comprised of two layers; a conductive exterior layer 104 and a non-conductive interior layer 106. Both of the layers 104, 106 can be comprised of a polymeric, moldable material, and can be fabricated together as a single unit in a molding process. The conductive layer 104 is an electrically conductive material, that is sufficiently conductive to prevent an accumulation of static charge. The conductive material can have a resistance of 10⁹ ohms or less, as measured between two points that are 10 millimeters apart. The conductive layer 104 can be made of, for example, carbon-filled polycarbonate, stainless steel-filled polycarbonate, or an electrically conductive paint. The conductive and non-conductive layers 104, 106 can be distinguished by their surface resistance (i.e. electrical resistance), which is a measure of how easily electric charge can move through a medium. Conductive materials, for the purpose of this disclosure, have a surface resistance of less than 1×10¹¹ ohms/square unit of measure (i.e. between two parallel lines of length L that are separated by a distance L). Anti-static materials are generally materials that inhibit triboelectric charging. Given that conductive materials allow movement of charge sufficient to prevent triboelectric charging, conductive material constitutes an anti-static material. A non-conductive material, for the purposes of this disclosure, is an electrically insulative material having a surface resistance of greater than 1×10¹² ohms/square unit of measure. A region of the non-conductive layer 106 is exposed through the conductive layer 104 to form an antenna portion 108 of the housing 102. One or more antenna elements 110 are disposed on the antenna portion 108. The antenna element 110 can be formed as a planar element on the surface of the antenna portion 108, and can be printed or etched onto the antenna portion 108 using a metal such as, for example, copper. To connect to the antenna element 110, a conductive element 112 can be inserted, or insert molded, through the non-conductive layer to an interior region of the housing 102. Alternatively conductive element 112 can be a plated through-hole in some embodiments. The conductive element 112 can be contacted by, or connected to circuitry in the inside of the device housing 102. In some embodiments another antenna portion 114 can be formed at another location of the device housing 102, including a first antenna element 116 on the exterior of the antenna portion 114, and a second antenna element 120 on an interior of the antenna portion 114. The arrangement of placing the antenna element on a non-conductive antenna portion of the housing also eliminates having to place the antenna element on a printed circuit board inside the portable two-way radio device, as an individual component, thereby reducing the total number of parts required for manufacturing.

By using multiple antenna portions and/or multiple antenna elements, the device can support multiple different high frequency transceivers. For example, a device can include a WLAN transceiver and a PAN transceiver, in addition to a two-way transceiver. A WLAN transceiver can be used for data service, while a PAN transceiver can be used for wirelessly connecting to nearby devices and accessories. In some embodiments an antenna portion having an antenna element can be used for a Global Positioning Satellite (GPS) receiver.

FIG. 2 is a front view 200 of an antenna portion 204 and antenna 206 for a device, formed on the housing of the device, in accordance with some embodiments. The view 200 can be, for example, a view of a housing from the perspective of arrow 122 in FIG. 1. The housing includes a conductive exterior layer 202 that can be the same as exterior layer 104 in FIG. 1, and is comprised of a conductive, anti-static material. The antenna portion 204 is formed on a non-conductive interior layer from which the anti-static material of the conductive layer is excluded. The antenna element 206 is formed on the surface of the antenna portion 204, and can be connected to circuitry inside of the housing through a conductive element 210 at a feed point of the antenna element 206.

In order to meet standards for intrinsically safe devices, the antenna portion can be limited in area to being not more than two thousand square millimeters in some embodiments. The antenna element can be limited to an effective area 208 of thirteen hundred square millimeters in some embodiments. In addition, the antenna element 206 can be arranged on the antenna portion 204 such that no portion of the antenna element is within three millimeters (as indicated by 212) of the anti-static material of the exterior layer 202. The effective area 208 of the antenna element 206 can be defined by the area inside a region around the outermost edges of the antenna element.

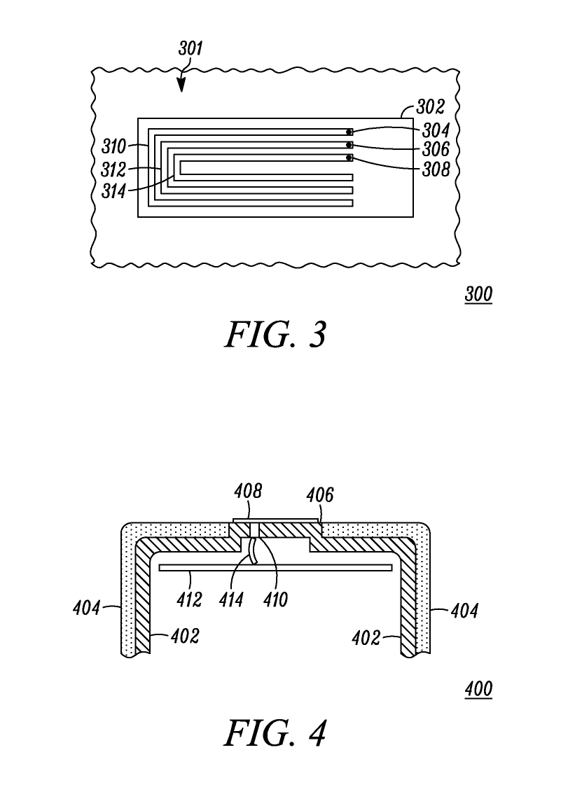

FIG. 3 is plan view 300 a plurality of nested antenna elements 310, 312, 314 on an antenna portion 302 of a device housing, in accordance with some embodiments. The antenna portion 302 is formed on a non-conductive surface on a device housing from which anti-static material 301 covering the housing has been excluded. The anti-static material can be, for example, an exterior layer of the housing comprised of a conductive material in some embodiments. In some embodiments the anti-static material can be a conductive paint. Each of the antenna elements 310, 312, 314 can be printed, etched, plated, or otherwise disposed in the antenna portion 302 and can be comprised of a suitably conductive material such as, for example, copper or an equivalent metal. By nesting the antenna elements, each antenna element 310, 312, 314 can have a different length, and therefore each antenna element 310, 312, 314 can be optimized for a different frequency band. Each of the antenna elements 310, 312, 314 have a respective feed point 304, 306, 308 that can be connected to a different corresponding transceiver circuit inside the device using, for example, a conductive insert or plated through hole via. Alternatively, each antenna element can be coupled to the same transceiver, and can allow for desired frequency diversity of the transceiver. The antenna portion 302 does not encompass a large enough area to accumulate sufficient static charge to be of concern for intrinsically safe standards, and as in FIGS. 1-2 can be no more than two thousand square millimeters in area. Likewise, the antenna elements 310, 312, 314 are positioned in such a way that no portion of any of the antenna elements 310, 312, 314 are closer than a minimum spacing from the conductive anti-static material 301 for RF performance. In some embodiments the antenna elements 310, 312, 314 can maintain a spacing of at least three millimeters from the anti-static material 301.

Although shown in FIG. 3 as nested “U” or “C” shaped elements, generally, the antenna elements do not have to shaped that way and can take on any suitable shape or path. Likewise, in some embodiments, rather than being nested, there can be multiple antenna elements that share the antenna portion area 302 but are not nested. In some embodiments there can be an antenna element on the exterior surface of the antenna portion 302 and another antenna element on an interior surface of the antenna portion as shown, for example, in FIG. 1, referring the elements 116, 120, which can be used by the same radio circuitry, or different radio circuitry.

FIG. 4 is a top cutaway view of a device assembly 400, in accordance with some embodiments. The device assembly 400 includes a housing comprised of an inner or interior layer 402 and an exterior layer 404. The interior layer 402 is made of a non-conductive material, such as a polymeric material. The exterior layer 404 is made of an anti-static material that is electrically conductive. An antenna portion 406 can be formed by exposing a section of the interior layer 402 through the exterior layer 404, which results in a region of the housing from which the anti-static material is excluded. The antenna portion 406 can be formed, for example, by co-molding the interior layer 402 with the exterior layer where the mold tool is shaped to exclude the exterior layer 404 from the antenna portion using conventional molding techniques. At least one antenna element 408 is disposed on the antenna portion 406, and is fed by a conductive element 410. A circuit board 412 can contain radio circuitry that is connected to the conductive element 410 via a spring contact 414. The spring contact 414 can be of a length such that the circuit board 412 and antenna element 408 are separated by a desired distance. In some embodiments the distance between the antenna element 408 and the circuit board can be at least three millimeters. In some embodiments the distance between the antenna element 408 and the circuit board can be at least three millimeters and not more than five millimeters. In some embodiments where there are multiple antenna elements 408, there can be a corresponding number of conductor elements 410 and spring contacts 414 that can connect to antenna elements 408 disposed on antenna portion 406, or on another antenna portion elsewhere on the housing.

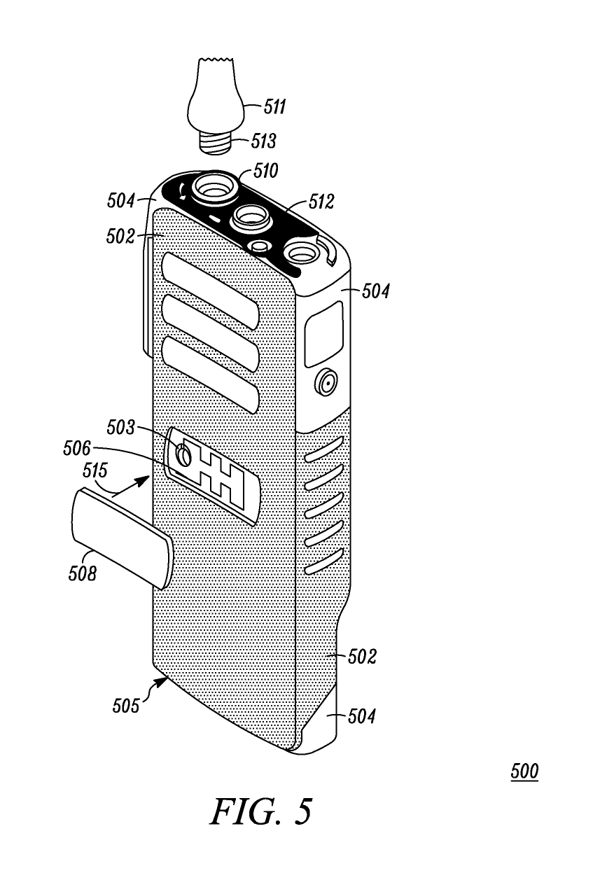

FIG. 5 is an isometric view of a portable two-way radio device 500 having an electrically conductive exterior layer 502 and an antenna portion 503 formed on an exposed region of a non-conductive interior layer 504 of the housing, in accordance with some embodiments. The conductive layer 502 covers substantial portions of the device surface, including side and a majority of the front surface 505 of the device, but is excluded from areas close to connectors and other components, such as area 512, that protrude through the housing of the portable two-way radio device 500. The conductive layer 502 is comprised of an electrically conductive anti-static material and the interior layer 504 is comprised of a non-conductive material. An antenna element 506 is disposed on the antenna portion 503 on a front face or surface of the portable two-way radio device, and is connected to radio circuitry inside the portable two-way radio device 500, such as a WLAN or PAN transceiver for short range communication. A label 508 or other cover can be placed over the antenna portion 503 to conceal the antenna portion 503 and antenna element 506, as indicated by arrow 515. In addition to the antenna element 506, the portable two-way radio device 500 can include an antenna connector 510 for a whip antenna 511 that can be coupled to the connector 510 by a threaded terminal 513. The antenna connector 510 is located on a top section of the portable two-way radio device 500, and is used by a two-way radio transceiver of the portable two-way radio device 500 that operates in the very high frequency (VHF) band (30 MHz-300 MHz) or the ultra-high frequency (UHF) band (300 MHz-3 GHz), as is conventional for two-way radio operation. The portable two-way radio device 500, even though designed for intrinsically safe standards, retains a common aesthetic design with models not designed for intrinsically safe operation. A non-intrinsically safe portable two-way radio device lacks the conductive exterior layer 502 and uses a non-conductive material to house the portable two-way radio device 500.

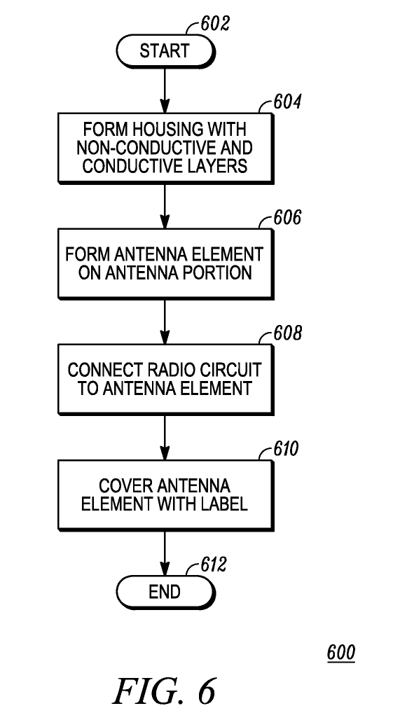

FIG. 6 is a flow chart diagram of a method 600 for forming a device housing having a conductive exterior layer for a portable device, in accordance with some embodiments. At the start 602 the necessary materials and tools are ready for use, including, for example, stock non-conductive plastic and stock conductive plastic as well as a mold tool or tools which form the heated plastic into a desired shaped. The housing can then be removed from the mold tool and left to cure. In step 604 the non-conductive plastic is formed into an interior layer of the housing and conductive plastic is formed into an exterior layer of the housing. The mold tool can exclude the conductive plastic from an antenna portion formed on the non-conductive interior layer. In step 606 at least one antenna element is formed on the antenna portion. The antenna element or elements are shaped for a desired frequency band for a radio circuit that will be connected to the antenna element and spaced appropriated from the conductive material of the exterior layer. In step 608 the radio circuit can be connected to the antenna element using, for example, a spring contact. The radio circuitry can be connected upon assembling the device. In step 610, the antenna element can be concealed by placing a label or other cover over the antenna portion. The label is made of a non-conductive material and will not substantially interfere with radio wave propagation. At the end 612 the device is assembled and ready for use.

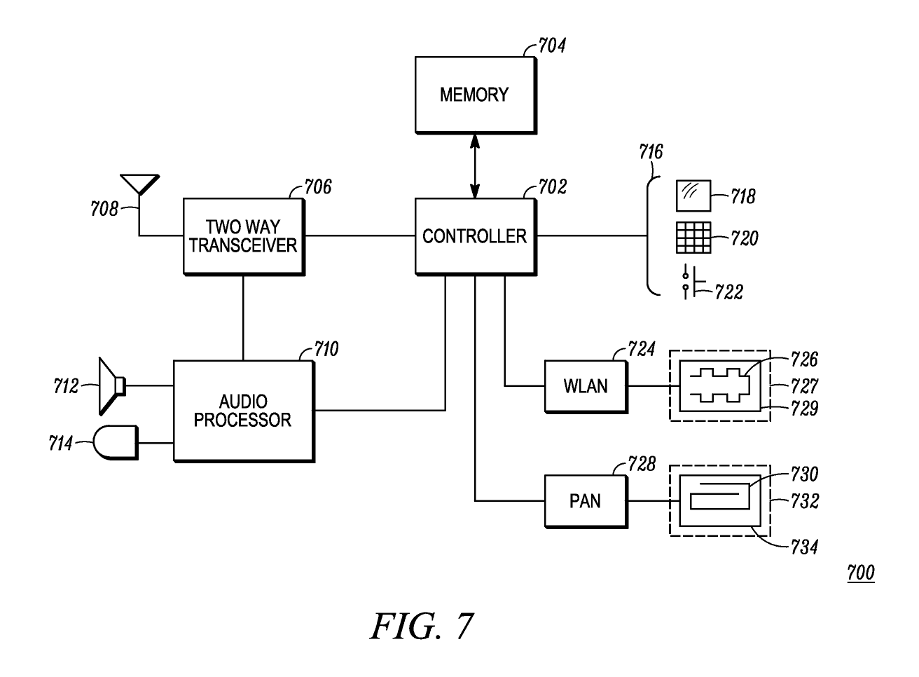

FIG. 7 is a block diagram of a portable two-way radio device 700 in accordance with some embodiments. The portable two-way radio device 700 can be substantially similar to that shown in FIG. 5. The portable two-way radio device 700 is primarily operated by a controller 702 that can be a microprocessor or microcontroller that performs instruction code. The instruction code is stored in a memory 704, which includes non-transitory computer readable storage media. The memory 704 can represent an aggregate of various memory types used by the controller 702, including random access memory (RAM) for instantiating executable code, variables, and other data structures. The controller is coupled to a two-way radio transceiver 706 which facilitates two-way radio functionality, including “push to talk” voice communication. The two-way transceiver 706 uses a two-way antenna 708 that can be, for example, a quarter wave whip antenna. Typically, in a portable two-way radio device configuration, the two-way antenna 708 extends from a top portion of the portable two-way radio device. Voice communication is further facilitated by an audio processor 710 that can be coupled, and responsive to, both the two-way transceiver 706 and the controller 702. The audio processor converts digital audio signals received by the two-way transceiver 706 into corresponding analog audio signals that are played over a speaker 712 to produce acoustic audio signals that can be heard by a user of the portable two-way radio device 700. Similarly, a microphone 714 is used to receive acoustic audio signals, such as the speech of a user of the portable two-way radio device 700, which produces analog (electrical) audio signals that converted to digital audio signals by the audio processor 710, which forwards the outbound digital audio signals to the two-way transceiver 706 for transmission via radio waves. The controller 702 is further coupled to user interface elements 716, which can include a graphical display 718 for displaying information that can be visually perceived. The user interface elements 716 can further include a keypad 720 or other buttons, knobs, selectors and other mechanically operated elements to input information and settings to the portable two-way radio device 700. A PTT button 722 is used to control two-way communication. Then the PTT button is actuated, the portable two-way radio device 700 will commence transmitting audio signals received at the microphone 714, or at a connected accessory microphone, via the two-way transceiver 706. When the PTT button is released transmission will be stopped and the two-way transceiver 706 will resume standby or monitoring mode.

The portable two-way radio device 700 can further include one or more additional transceivers, such as, for example, a WLAN transceiver 724 and a PAN transceiver 728. The WLAN transceiver 724 can operate according to IEEE standard 802.11 and is used for wireless data services networking (also referred to as “WiFi”). The PAN transceiver 728 can be used for wirelessly connecting the portable two-way radio device 700 to other devices, such as, for example, a vehicle system, wearable audio accessories (e.g. remote microphone, headphones) and can operate according to IEEE standard 802.15, including that known commercially as “BlueTooth.” The WLAN transceiver is coupled to a WLAN antenna element 726 that is disposed on a WLAN antenna portion 729 on exterior surface are 727 that is otherwise covered in anti-static material. The anti-static material is excluded from the antenna portion 729. Likewise, the PAN transceiver 728 is coupled to a PAN antenna element 730 that is disposed on a PAN antenna portion 734 on exterior surface are 732 that is otherwise covered in anti-static material. The anti-static material is excluded from the antenna portion 734. In some embodiments the WLAN antenna portion 729 and the PAN antenna portion can be separate portions, and in some embodiments they can be the same antenna portion with the WLAN antenna element 726 and the PAN antenna element 730 sharing the joint antenna portion. The antenna portions 729, 734 can be covered with a non-conducting material (e.g. a label) to conceal and protect them. The antenna portions 729, 734 have an area that is small enough to prevent accumulation of static charge that exceeds an amount allowed by, for example, intrinsically safe standards.

Embodiments provide the benefit of allowing a portable radio device with multiple transceivers to comply with intrinsically safe design standards without requiring additional, apparent antennas outside of a conductive exterior surface, thus maintaining desired ergonomics and aesthetic design compared to similar devices that are not designed to be used under intrinsically safe standards. Furthermore, by forming one or more antenna elements on the housing of the portable radio device, the housing with the antenna element(s) can be considered a single piece part for manufacturing, thereby eliminating, for example, the use a of separate printed circuit board to carry an antenna element. Also, in prior art implementations where the antenna element was included on the printed circuit board with other components, embodiments of the present disclosure provide a gain of area on printed circuit boards since the antenna element is no longer on the circuit board but rather placed on the housing.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment for forming the housing using an automated mold tool can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A portable two-way radio device, comprising:
a housing having an outer surface that is covered with an anti-static material, and wherein the anti-static material is excluded from an antenna portion of the outer surface of the housing;
at least one antenna element formed on the antenna portion, and having a feed point that is connected to an interior space of the portable two-way radio device through the housing, wherein the at least one antenna element is a planar element disposed on a surface of the antenna portion; and
a radio circuit disposed in the interior space of the portable two-way radio device that is coupled to the at least one antenna element.

2. The portable two-way radio device of claim 1, wherein the antenna portion has an area not greater than 2000 square millimeters.

3. The portable two-way radio device of claim 1, wherein the antenna portion has a border, no part of the at least one antenna element is within 3 millimeters of the border.

4. The portable two-way radio device of claim 1, wherein the anti-static material has a resistance of less than 10⁹ ohms as measured between any two points of the anti-static material spaced 10 millimeters apart.

5. The portable two-way radio device of claim 1, wherein the at least one antenna element occupies an effective area of not more than 1300 square millimeters of the antenna portion.

6. The portable two-way radio device of claim 1, further comprising a label placed over the antenna portion.

7. The portable two-way radio device of claim 1, further comprising a second antenna element that is disposed on an interior surface of the antenna portion that is opposite from the at least one antenna element.

8. The portable two-way radio device of claim 1, wherein the housing is formed of a non-conductive inner enclosure layer that has a conductive outer enclosure layer over-molded over the non-conductive inner enclosure layer, wherein the conductive outer enclosure layer is made of the anti-static material, and wherein the antenna portion is a portion of the non-conductive inner layer that is exposed through the conductive outer enclosure layer on an outside of the housing.

9. The portable two-way radio device of claim 1, wherein the at least one antenna element is a printed or etched antenna element on the antenna portion.

10. The portable two-way radio device of claim 1, wherein the radio circuit is coupled to the at least one antenna element through a spring contact that maintains a space between the radio circuit and the at least one antenna element of at least 3 millimeters.

11. The portable two-way radio device of claim 1, wherein the at least one antenna element comprises a plurality of antenna nested elements formed on a surface of the antenna portion.

12. The portable two-way radio device of claim 1, wherein the antenna portion comprises a printed circuit board insert molded into the housing.

13. The portable two-way radio device of claim 1, wherein the radio circuit is one of a personal area network transceiver, a global positioning satellite receiver, or a wireless local area network transceiver.

14. The portable two-way radio device of claim 1, further comprising a two-way antenna coupling for a two-way transceiver of the portable two-way radio device.

15. The portable two-way radio device of claim 1, wherein the at least one antenna element comprises a short range antenna element for use in connecting the portable two-way radio device to at least one of a personal area network or a wireless local area network.

16. The portable two-way radio device of claim 1, wherein the at least one antenna element is a first antenna element and the antenna portion is a first antenna portion, the portable two-way radio device further comprises a second antenna portion formed on the housing from which the anti-static material is also excluded, and a second antenna element disposed on the second antenna portion.

17. A housing for an intrinsically safe portable radio device having an exterior, comprising:
an anti-static material disposed on a majority of the exterior of the housing;
an antenna portion on the exterior of the housing where the anti-static material is excluded and that does not exceed 2000 square millimeters in area; and
at least one antenna element disposed on the antenna portion and having a planar configuration on a surface of the antenna portion and a feed point, wherein the at least one antenna element occupies a region of not more than 1300 square millimeters of the antenna portion and no portion of the at least one antenna element is closer than 3 millimeters to the anti-static material.

18. The housing of claim 17, wherein the anti-static material is a conductive layer of the housing, and wherein the housing further comprises a non-conductive layer over which the conductive layer is molded, wherein the antenna portion is formed by excluding the conductive layer from a portion of the non-conductive layer.

19. The housing of claim 18, wherein the at least one antenna element is on an exterior surface of the antenna portion, the housing further comprises a metal insert molded into the antenna portion at the feed point and passing completely through the non-conductive layer to form a contact point.

20. The housing of claim 17, wherein the anti-static material has a resistance of less than 10⁹ ohms as measured between any two points of the anti-static material spaced 10 millimeters apart.

21. A method of forming a housing for a portable radio device, comprising:
molding an interior layer of the housing with a non-conductive material;
molding an exterior layer of the housing with a conductive material over, and integrally with the interior layer, wherein the conductive material is excluded from an area of the interior layer to form an antenna portion; and
forming an antenna element on the antenna portion.

22. The method of claim 21, further comprising, covering the antenna portion with a label after forming the antenna element.
